(19) United States
(12) Patent Application Publication
(10) Pub. No.: US 2007/0058374 A1
(43) Pub. Date: Mar. 15, 2007

(54) Luminaire Reflector Having Attachment Ring

(75) Inventor: Scott Dupre, Fall River, MA (US)

Correspondence Address: MIDDLETON & REUTLINGER, 2500 BROWN & WILLIAMSON TOWER, LOUISVILLE, KY, 40202, US

(73) Assignee: Genlyte Thomas Group, LLC, Louisville, KY (US)

(21) Appl. No.: 11/419,720

(22) Filed: May 22, 2006

Related U.S. Application Data
(60) Provisional application No. 60/683,645, filed on May 23, 2005.

(51) Int. Cl. F21V 7/00

(52) U.S. Cl. 362/341

(57) ABSTRACT

A friction spring reflector assembly is described, the reflector attachment mechanism utilizing a push-on friction ring which acts alone or in combination as a mounting ring for mounting additional hardware such as a lens to a curved reflector cone without the use of adhesives or mounting bolts. The push-on friction ring maintains position through the use of a plurality of teeth which frictionally engage grooves or the smooth side wall of the reflector cone.

### CROSS REFERENCE TO RELATED APPLICATIONS

This application claims the benefit of and priority to U.S. Provisional Application No. 60/683,645, filed May 23, 2005, the entire disclosure of which is incorporated herein by reference, under 35 USC 119(e).

### TECHNICAL FIELD

The present invention is related to a luminaire reflector and in particular a luminaire reflector which has an attachment ring frictionally engaged against the reflector, the attachment ring utilized to affix hardware to the reflector.

### BRIEF DESCRIPTION OF THE DRAWINGS

FIG. 1 is a perspective view of the luminaire reflector having a frictional attachment ring of the present invention;

FIG. 2 is a side view of the luminaire reflector having a frictional attachment ring of the present invention;

FIG. 3A is a perspective view of a reflector utilized in the present invention;

FIG. 3B is one embodiment of the retainer cup utilized in the luminaire reflector having an attachment ring of the present invention;

FIG. 4A is a side view of another embodiment of the reflector friction ring and spring cup of the present invention;

FIG. 4B is a perspective view of the spring cup utilized of the present invention;

FIG. 4C is a top view of the annular friction ring utilized in the present invention;

FIG. 4D is a side-sectional view of the annular friction ring utilized in the present invention;

FIG. 5A is a side-sectional view of an alternative embodiment for a reflector cone and spring cup with friction ring utilized in the present invention;

FIG. 5B is a close-up side-sectional view of the friction ring with integrated friction teeth of the present invention;

FIG. 6 is a perspective view of an alternative construction of the luminaire reflector having a frictional attachment ring utilized in the present invention;

FIG. 7 is a top perspective view of another embodiment of the present invention detailing a reflector with attachment ring and spring clips.

### DETAILED DESCRIPTION OF THE PREFERRED EMBODIMENTS

In normal luminaire construction, particularly with regards to recessed luminaries, it is desirous to insert within the luminaire housing a reflector cone which typically is inserted either around or directly below the lamp of the luminaire. In such designs, it is commonly desirous to attach various lens or other hardware to the trim cone or reflector cone in order to modify the illumination characteristics of the luminaire and particularly of the reflector or reflector cone. In many instances, it is desirous to attach to the reflector cone a lens for coloring of the lamp or for re-direction of the light therefrom. It may also be desirable to attach other hardware to the trim cone such as hinges or other affixation mechanisms directly such that attachment of various luminaire hardware directly to the trim cone may be achieved.

Heretofore, it has been difficult to attach hardware directly to the trim cone due to its smooth finished surface on the exterior thereof, mostly because the trim cone is made of steel or other processed material. Further, the trim cone or reflector is normally smoothed, curved or parabolic in shape curving upwardly and inwardly from the lower most flange and aperture to an upper aperture into which the light or lamp output is directed. This upwardly and inwardly directed curved shape in combination with the smooth surface of the material utilized for the reflector or trim cone makes difficult direct attachment of hardware to the exterior surface of the trim cone or reflector particularly without the use of attachment bolts.

Heretofore, rings have been affixed to the exterior surface of the trim cone and these rings, which are utilized for affixing various hardware to the reflector cone, are adhered to the external surface of the trim cone utilizing epoxy adhesives or bolts. Use of adhesive or other materials during the manufacturing process produces difficulty in that additional steps are required during assembly. Further, the addition of a foreign substance such as epoxy or adhesive material to a light fixture produces long term issues related to maintaining the adhesive contact between the ring and the exterior surface of the trim.

It is therefore desirable to provide a mechanical attachment means which allows affixation of various hardware assemblies directly to the exterior surface of the smooth curved reflector trim cone without the use of adhesives or epoxy material.

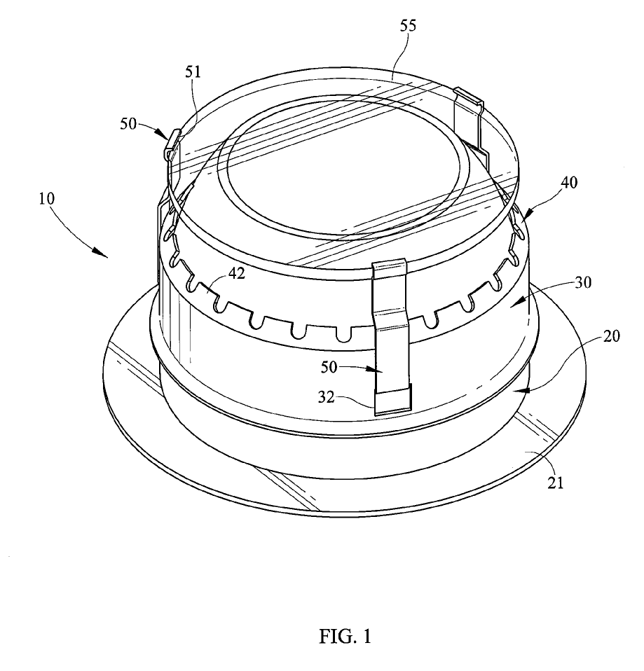

The luminaire reflector having an attachment ring 10 utilized in the present invention is depicted in FIG. 1 and allows direct attachment of various hardware devices such as a lens or other materials to the reflector without the use of mounting bolts or adhesives.

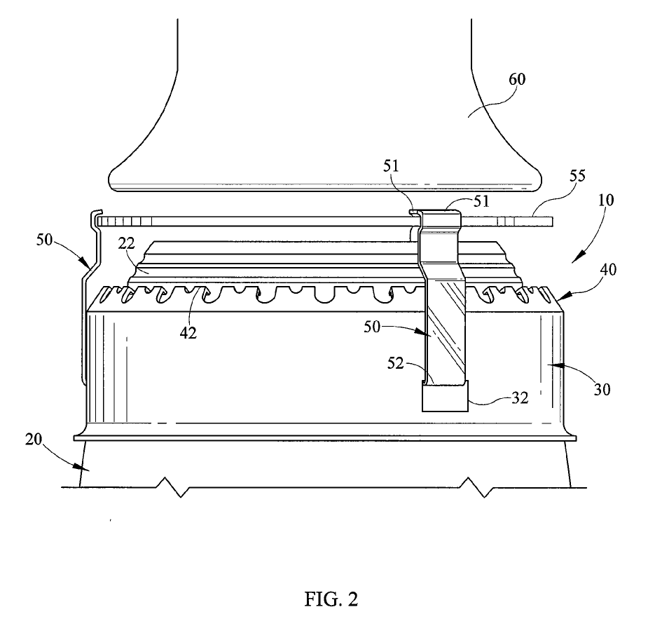

As shown in FIG. 1, a trim cone or reflector cone 20 is depicted which has an outwardly extending flange 21 along its lower portion thereof and which forms a lower aperture of the reflector cone. In this embodiment, a lens 55 is desired to be affixed to the upper aperture area of the reflector cone 20 since the lamp will be positioned directly above the upper aperture. By placement of the lens 55 in between the lamp 60, as is shown in FIG. 2, and the upper aperture of the reflector cone, modification of the right characteristics may be achieved.

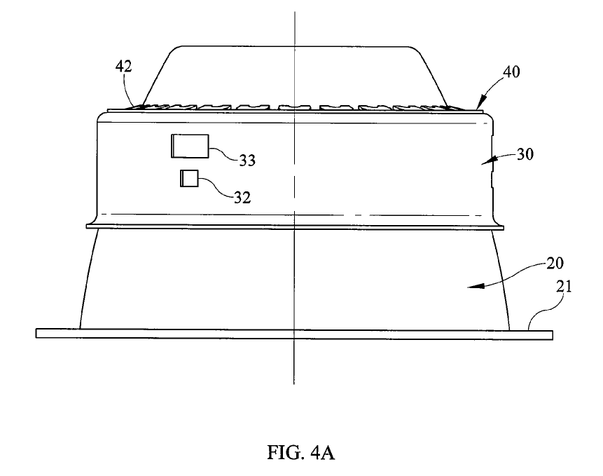

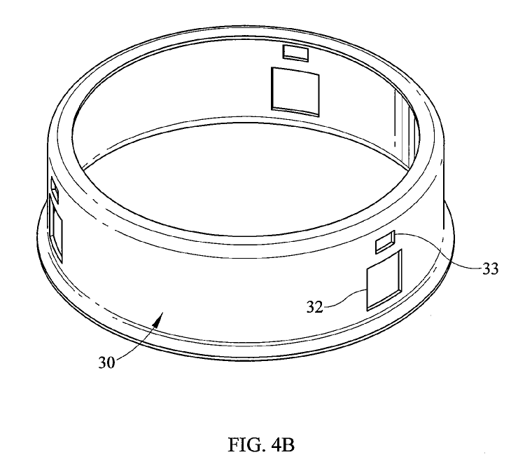

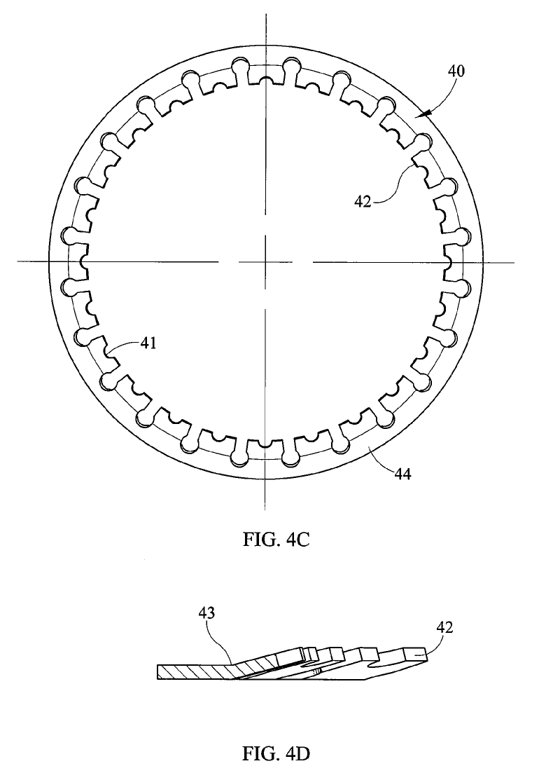

In the present design, the reflector cone 20 has attached directly to its exterior surface a spring cup 30 which is non-removably installed to the outer side wall of the trim cone 20. The spring cup 30 works in combination with an annular friction ring 40, the annular friction ring 40 having a plurality of teeth or springs 42 which are directed inwardly therefrom. The friction ring 40, shown more closely in FIGS. 4C and 4D, has a flat outer peripheral section 44 and extending inwardly therefrom a plurality of teeth or springs 42 which, as is shown in FIG. 4D, deflect upwardly at about 15°. A circular bend line 43 separates the outer flat ring 44 and the teeth 42. The teeth as shown in FIGS. 4C and 4D, may have a U-shape cutout portion 41 which forms on each individual tooth a first and second contact surface for frictionally engaging the outer wall of the reflector cone in order to lock in vertical alignment the ring 40 as well as any other hardware attached thereto. As shown, a plurality of grooves may be machined into the side wall of the curved reflector cone. As a reflector cone is typically made of hardened material such as steel and the like, frictional or locking engagement with the grooves by teeth 42 aids in the retention of the push-on friction ring 40 with the reflector cone 20. The formation of the grooves 22 formed into the side wall of the cone 20 may aid in this frictional locking engagement. However, given the various possible designs of the teeth or other gripping surfaces formed on each ring, grooves do not necessarily need to be formed into the side wall. Thus, adequate frictional engagement may be accomplished through various teeth designs formed on the push-on friction ring 40 in order to adequately maintain the friction ring and other mounting hardware in position on the exterior of the reflector cone. Additionally, while the reflector cone shown herein has typically been shown as a curved reflector cone, various reflectors, shapes and designs may be utilized in combination with the novel mounting mechanism depicted herein. The specific embodiments shown are not meant to be limiting and are merely being utilized to convey an understanding of the friction ring reflector assembly depicted herein.

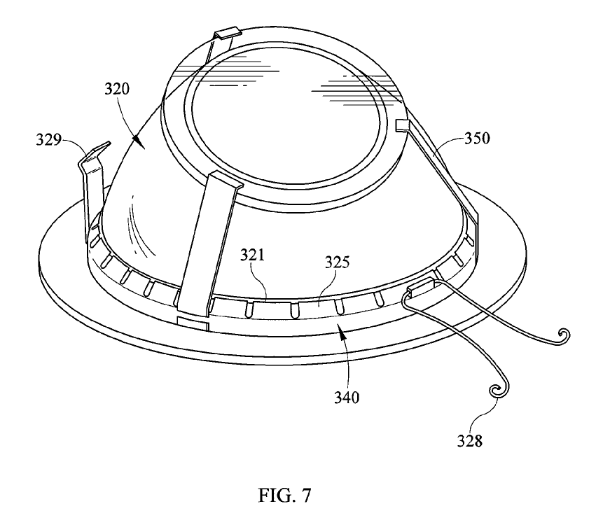

As shown in the various embodiments, the reflector cone 20 is typically a smooth curved surface which is directed upwardly and inwardly from the flange 21. While the reflector cone 20 may be described as a parabolic curve, any conical parabolic, curved or straight cone may be utilized with the inventive reflector attachment mechanism described herein. The reflector cone, as is shown in the multiple embodiments, may have an upper aperture for direct affixation of a lens and a lower aperture which is typically defined by an outwardly extending flange. The side wall forming the upper aperture of the reflector may form the upper aperture along a plane which is parallel to the plane defined by the lower flange 21 as shown in FIG. 1. Alternatively, as is depicted in FIG. 6 and in FIG. 7, the upper aperture may form a first plane which is at an angle relative to the plane formed by the perimeter of the lower aperture of the reflector 320. In such instance where the plane on which the upper aperture is located at an angle relative to the plane formed by the lower aperture, various retention mechanisms are necessary to maintain the lens 355 in proper position These various mechanisms will be discussed herein.

Returning to the luminaire reflector attachment mechanism 10 of the present invention, as disclosed in FIG. 1, the curved reflector 20 has affixed to its exterior thereof the annular friction ring 40. The annular friction ring 40 has a plurality of inwardly and possibly upwardly directed teeth or fingers 42 which engage the exterior surface or wall of the reflector cone 20. The annular friction ring 40 has an inner diameter between the teeth 42 which is larger than the top most diameter of the reflector cone 20 but much smaller than the widest point of the reflector near to the flange 21. Thus, the annular friction ring 40 may be inserted from the top of the reflector and pushed downward along the exterior side wall of the reflector 20 until the teeth 42 bend upwardly and retain the annular friction ring in position. In the friction rings flat state, the inner diameter of the teeth 42 should be approximately 0.150 inches smaller than the diameter point of engagement desired along the side wall of the reflector cone 20. By providing a small offset of 0.150 inches, upward deflection of the teeth may be achieved and full installation of the friction ring on the reflector cone 20 is possible. However, this deflection amount and diameter calculation may be modified depending on the relative deflective capability of the individual teeth or with the design of the teeth and interface of the teeth with the side wall of the reflector cone.

In combination with the annular friction ring 40 is utilized a spring cup 30 which may be located directly below the annular friction ring. Similar to the annular friction ring 40, the spring cup 30 may have a diameter which is less than the widest diameter of the curved reflector cone 20 near the flange 21 but which is greater than the top most section of the reflector cone 20 opposite the flange 21. Thus, the spring cup 30 may slide over the exterior of the reflector cone 20 and be allowed to be in position at a given point wherein the inner diameter of the spring cup 20 matches or is less than the diameter of the reflector cone 20.

Positioned over the spring cup 30 in this one exemplary embodiment is pressed the annular friction ring 40 which is pushed downward along the exterior wall of the reflector cone 20 in order to retain the spring cup 30 in position. By virtue of the teeth 42 contacting the exterior surface of the reflector cone along an upper edge or wall thereof, the annular friction ring 40 is not easily removed from the reflector 20 once it is pressed into position as the teeth are annularly upwardly directed against the exterior surface and frictionally engage the exterior surface of the reflector cone 20.

In order to aid in this non-removal of the annular friction spring 40, a plurality of cone ribs, grooves or protuberances may be positioned along the exterior surface of the outer wall of the reflector cone 20. These ribs 22 may be machined or formed in the exterior surface of the cone and may be continuous, discontinuous, inset, extend out or merely multiply positioned in order to contact various teeth 42 of the annular friction ring. The grooves 22 positioned on the exterior surface of the reflector cone 20 therefore allow the annular spring 40 to be installed along the exterior of the reflector cone 20 while preventing the removal thereof after installation while locking the ring 40 in place. The grooves protuberances, notches or ribs may be machined into the reflector cone 20 and represent a position which the annular friction ring 40 will discontinue traveling downward or upward. A plurality of the grooves 22 may be machined into the cone to accommodate various aperture diameters and hardware attachments desired as well as for different vertical positioning of the annular friction ring 40 and attachment hardware.

As can be understood, it may be desirous to locate the annular friction ring 40 at different positions vertically along the side of the reflector cone 20 due to hardware which is attached either directly to the annular friction ring 40 or to the spring cup 30. As shown in the examples, and particularly as is shown in the embodiment of FIG. 1, the spring cup 30 is positioned directly below the annular friction ring 40 and locked in place. The spring cup 30 has an aperture 32 as well as a retaining aperture 33 located directly there-above which may maintain a spring clip 50 in position. The spring clip 50 has at its upper end a clasp for retaining a lens 55 directly over the top of the top end aperture of the reflector cone 20. As shown in the example of FIG. 2, the lens 55 is positioned directly below a lamp 60 such that light which shines through the cone 20 must first pass through the lens 55. The lens 55 is maintained in position without the use of adhesives or other epoxy material and is firmly and mechanically retained in position above the top end aperture of the reflector cone 20 through the use of the frictional engagement of the annular friction ring 40 in combination with the spring cup 30 and the grooves 22 machined onto the side of the top end of the reflector cone 20.

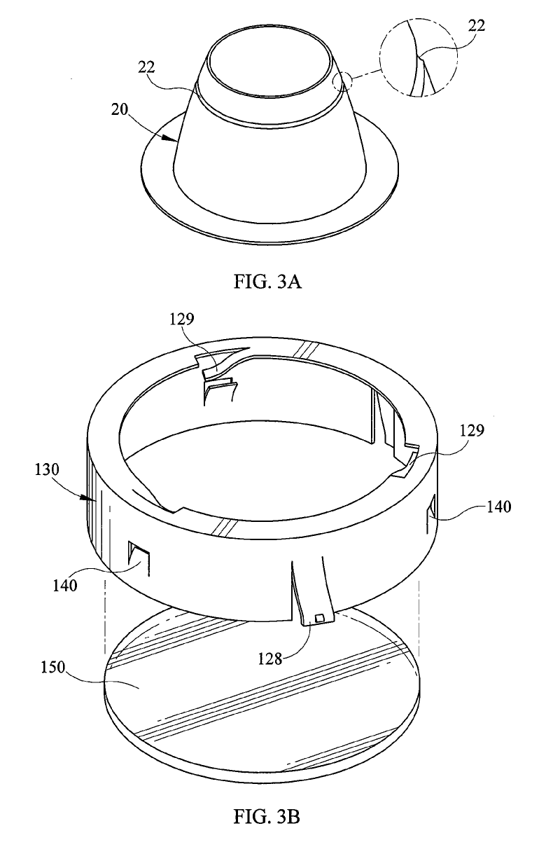

Turning to the annular friction ring 40 shown in the example, the annular friction ring has an inner diameter formed and measured from the teeth 42 which may engage the side wall of the upper portion of the reflector cone 20 at a proper position in order to lock the spring cup 30 in tight relationship so that it may not travel vertically along the curved side wall of the annular reflector cone 20. Thus, the diameter measurements of the annular friction ring 40 must be determined along with the innermost diameter of the teeth 42 as well as the proper position for engagement of the grooves 22 in combination with the contacting point of the lower edge of the spring cup 30 with the reflector cone 20 so that it may not travel vertically downward along the reflector cone once in proper vertical position Additionally, the annular friction ring 40 and the plurality of teeth 42 formed thereon may be directly combined with the spring cup 30 or with other hardware attaching mechanisms to affix hardware directly to the exterior of the reflector cone 20. Thus, as is depicted in the embodiment of FIGS. 3A and 3B, a combined retainer cup 130 has a plurality of spring features 129 which prevent the glass from rattling or vertically traveling once placed within the interior of the retainer cup 130, as well as a plurality of retaining tabs 128 which may be provided and which are lanced outward to provide friction in order to retain the assembly within a luminaire housing. Further, a number of lanced tabs 140 may be lanced and directed inward in respect to the side wall of the retainer cup 130, the lanced tabs 140 engaging with the grooves 22 machined on the cone 20 shown in FIG. 3A. A lens 150 may be inserted and held into place directly above the upper aperture of the cone 20, the lens retained there by downward pressure of the spring feature 129 and compressed directly along the upper aperture edge of the cone 20.

In this embodiment depicted in FIG. 3A and FIG. 3B, the lanced tabs 140 act as the annular friction ring teeth and maintain a vertical position along the side wall of the cone 20 through engagement of the groove 22 machined in the side wall of the cone 20 in combination with the diameter of the lower edge of the retainer cup 130 such that the retainer cup 130 may not travel vertically, either downward or upward along the side wall of the cone 22.

In other words, the retainer cup 130 depicted in FIG. 3B provides a means or mechanism to attach the glass lens 150 to the trim cone 20 without epoxy or other adhesive means by inserting the lens into the retainer cup 130, the retainer cup and lens then fitted onto the top of the trim cone 20 until the lanced tabs 140 engage the groove 22 machined into cone 20. The plurality of lances 128 provide a mechanism or means to hold the entire assembly into the luminaire housing into which the combined retainer cup 130, glass lens 150 and cone 20 is inserted.

Returning to the annular friction ring 40, shown in FIG. 1 and FIG. 2, the plurality of teeth 42 and the friction ring 40 are more closely depicted in FIGS. 4C and 4D. Each of the plurality of teeth 42 may have a U-shaped inset 41 or cutout formed therein which assures each of the individual teeth has two engagement surfaces. The teeth 42 are formed typically along a circular bend line 43 at about a 15° upward angle. Typical thickness for the stainless steel or other material with which the annular friction ring is made, may be about 0.015 inches while the vertical dimension of the ring 44 and upwardly deflected teeth 42 may be 0.05 inches.

The cone retention ring or friction ring 40 depicted may be in combination with the spring cup shown in FIG. 4B and as exemplary installed in FIG. 4A. The retention ring 40 is shown with the plurality of teeth 42 angled upwardly which may further be deflected upon installation on the exterior of the reflector cone 20. The spring cup 30 may have a plurality of cup apertures 32 and retaining apertures 33, preferably positioned 120° apart, such that the spring clips 50 may be evenly and accurately displaced about the spring cup 30 in order to evenly retain the lens 50 and position the lens in proper location relative to the cone. The spring clips 50 may have an upper end with the clasp 51 directly engaging of the lens 55 and positioning the lens along the top edge of the cone 20, and may also have a lower U-shaped hook end 52 which engages the top edge of the cup aperture 32 while also possibly being long enough to snap outward into position and lock the spring clip therein by positioning this extension portion through the retaining aperture 33. Thus, the hook end 52 of the spring clip 50 may be U-shaped to firmly retain the spring cup 30 in position and maintain the spring clip 50 in proper location due to the action of the hook end 52, the very end of the spring clip at the hook end 52 pressing outward through the retaining aperture 33.

The embodiments shown in FIGS. 4A, 4B, 4C and 4D indicates that installation and retention for decorative lens without the use of mounting screws or epoxy adhesives may be accomplished through the use of frictional engagement between the exterior surface of the reflector cone 20 and mounting hardware, the mounting hardware in this one embodiment being the spring cup 30 in combination with the annular friction ring 40 or with a combined spring cup and annular friction ring 130 as depicted in FIG. 3B. In both instances, inwardly directed frictional engagement mechanisms are utilized to interface with a plurality or singular groove 22 formed in the exterior side wall of the curved reflector cone 20.

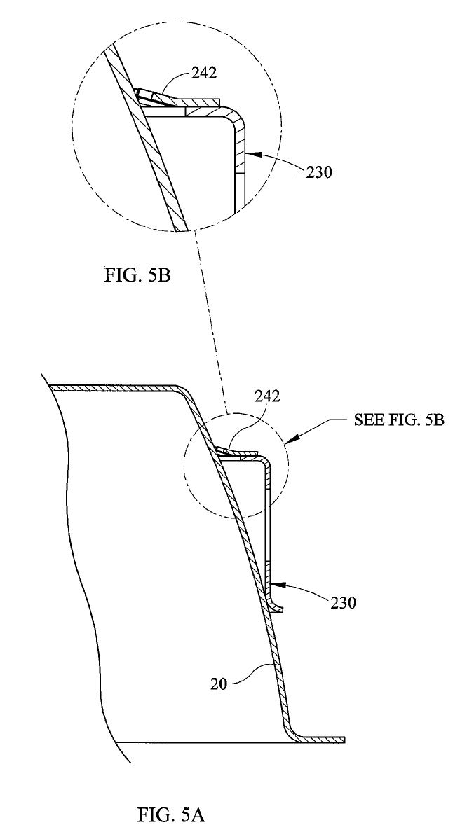

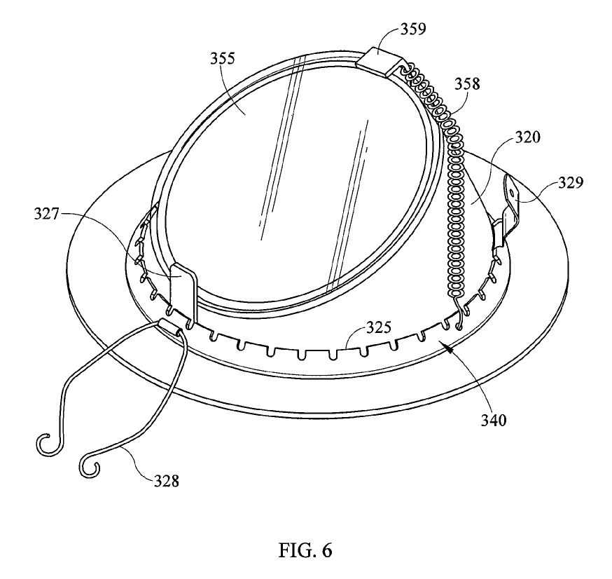

As may well be appreciated, a plurality of decorative features may be installed appropriately on the cone 20 or adjacent to the lamp 60 within the housing of the luminaire. The attachment mechanism depicted herein may be utilized singularly or in combination with other mechanisms in order to affix various hardware structure directly to the exterior of the cone 20 when necessary to affix lens or other such material thereto without the use of adhesives, epoxies or mounting screws and the like. The annular friction ring and the retainer cup may be combined, as previously indicated, and as is shown in FIG. 5A FIG. 5B wherein the retainer cup 230 has integrated clips 242 formed along a top edge thereof and which may be deflected such that the cup 230 forms a push-on ring which is retained on the reflector cone 20. As such, in the various designs, the springs flat state should have an inner diameter of the teeth being about 0.150 inches smaller than the point of engagement of the cone 20 and the teeth should be pre-bent as previously indicated to approximately 15°. Once installed in the various embodiments depicted herein, the teeth should be angled upwardly at about 30° for optimal grip and possibly form a moment arm of about 0.175 inches in length. A burr may also be formed on the underside of the teeth to increase the frictional engagement between the tooth or finger and the side wall of the reflector. As previously indicated, the ring, once fully installed and engaged due to the activity of the integrated clips 242 may be utilized for attachment of various accessories through the use of spring clips or accessory holders.

Turning to an additional embodiments depicted in FIG. 6 and FIG. 7, the reflector cone 320 is combined with a push-on ring 340 which has integral retention springs 329 as well as an integral stop 327. A plurality of teeth 325 are also formed thereon and affixed to frictionally engage the exterior side wall of the reflector cone 320. The teeth 325 may contact the grooves 321 shown in FIG. 7, in order to attach or maintain the vertical position of the push-on ring 340. A torsion spring or hinge 328 may be also provided in combination with the integral push-on ring 340 depicted so as to work in combination with the integral retention spring 329, a plurality of which may be utilized.

Further, clip 359 and stop 327 may work in combination with the lens 355 to position the lens at an angle along the top angled surface of the reflector cone 320, the clip 359 maintained in position to compress downward against the lens 355 by springs 358 to adequately position and retain the lens in proper place. Alternatively, springs 350 of FIG. 7 may similarly be used to hold a lens in place.

The torsion spring or hinge 328 works in combination with one or more integral retention springs 329 to maintain the trim ring and cone 320 within a luminaire housing. The torsion spring 328 is attached or affixed to hardware within the housing, not shown, located adjacent the aperture of the luminaire housing. Once the torsion spring 328 is affixed therein, the entire reflector cone assembly 320 in combination with the push-on ring 340 may be installed with the glass lens in place into the luminaire housing and directly adjacent to the lamp or light source. The hinge retains the reflector or trim member 320 in position within the luminaire while the integral retention springs 329 deflect inward of the housing aperture to allow installation into the luminaire housing. The integral retention springs 329 therefore, engage an interior surface of the aperture of the housing for mounting, as is commonly understood, within the luminaire, while the hinge allows the cone 320 to be accessed from below the housing by allowing the cone or reflector 320 to be swung downward about the hinge and retained in the housing by the hinge 328. The reflector cone and its assembly will hang from the luminaire housing by virtue of the mechanical attachment of the torsion spring or hinge 328 in combination with the mechanical attachment between the push-on ring 340 and the reflector cone 320 and the plurality of teeth 325 and the groove 321 formed into the side wall of the reflector cone 320. Thus, in this embodiment, the entire assembly is designed to be swiveled about the hinge out of the luminaire without the use of epoxy or further adhesives to attach hardware to the cone while also preventing the use of mounting screws and the like and only necessitating a simple push-on friction ring to secure all of the necessary hardware onto the reflector cone in order to retain the cone in hinged type connectivity therewith while also positioning a lens 355 or other hardware as is necessary.

The depiction of the various embodiments for the reflector cone or trim cone are shown with the understanding that the various trim cones may be installed in a standard luminaire as is known in the art. The combination with the reflector cone of a push-on friction ring for retaining mounting hardware may be integrated such that various mounting hardware are affixed to the cone without the use of adhesives, epoxy material or mounting bolts in such that frictional engagement between a mounting ring and the reflector cone is achieved in order to adequately mount hardware around or in proximity to the cone, the entire mounting assembly positioned within the standard luminaire housing as is known in the art. The assemblies of the reflector cone and push-on friction ring may be mounted within the luminaire housing, recessed pan or other luminaire device in many different constructions and any use of a push-on ring for affixing mounting hardware to the reflector cone is considered to fall within the teachings hereof. Various modifications may be understood and achieved through review of the teachings hereof and are meant to fall within the scope of the claims appended hereto.

I claim:

1. A luminaire reflector with an attachment ring, comprising:
a reflector cone;
an annular friction ring in frictional engagement along an exterior surface of said reflector cone;
an annular cup positioned adjacent said annular friction ring and retained on said reflector cone;
a lens positioned along an opened top aperture of said reflector cone by a plurality of spring retaining clips, said spring retaining clips retaining said lens in position on said reflector cone and affixed to said annular cup.

2. The luminaire reflector with an attachment ring of claim 1 wherein said friction ring has a plurality of inwardly directed teeth frictionally engaging said exterior wall of said reflector cone.

3. The luminaire reflector with an attachment ring of claim 2 wherein said reflector cone has at least one groove formed therein, said groove aligned with said plurality of teeth.

4. The luminaire reflector with an attachment ring of claim 2 wherein said plurality of teeth extend upwardly at about 15° from an outer flat ring.

5. The luminaire reflector with an attachment ring of claim 3 wherein said annular cup is positioned below said annular friction ring, said annular friction ring preventing vertical travel of said annular cup and said annular friction ring along said exterior of said reflector cone.

6. The luminaire reflector with an attachment ring of claim 1 where each of said plurality of spring clips have a hook end and a clasp at an opposite distal end, said clasp extending over said lens and said hook end extending through a cup aperture in the side wall of said spring cup.

7. The luminaire reflector with an attachment ring of claim 2 wherein said reflector cone is a curved reflector cone extending upward from a lower cone flange to an upper open aperture, said reflector cone curved inwardly more along its upper half as compared to its lower half.

8. The luminaire reflector with an attachment ring of claim 4 wherein each of said plurality of teeth has a U-shaped cutout, said U-shaped cutout forming a first and second engagement surface.

9. A luminaire reflector with a hardware attachment ring, comprising:
a reflector cone having a lower aperture and an upper aperture;
a hardware retaining ring extending along an outer periphery of said reflector cone, said hardware retaining ring having a plurality of inwardly directed tabs, said tabs in engagement with an exterior surface of said reflector cone to thereby frictionally retain said hardware retaining ring in vertical position in relation to said reflector cone.

10. The luminaire reflector with a hardware attachment ring of claim 9 wherein said hardware retaining ring has a top inwardly directed flange and a downwardly directed wall, said downwardly directed wall containing said plurality of inwardly directed tabs.

11. The luminaire reflector with a hardware attachment ring of claim 10 wherein said retaining ring top flange has at least one downwardly directed spring feature, said downwardly directed spring feature in contacting relationship against a lens, said at least one spring feature pressing said lens downward against a top rim surrounding said upper aperture of said reflector cone.

12. The luminaire reflector with hardware attachment ring of claim 10 wherein said hardware retaining ring has a plurality of retaining tabs extending outward from wall of said retaining ring to provide a frictional engagement with a luminaire housing assembly.

13. The luminaire reflector with hardware attachment ring of claim 9 wherein said reflector cone has at least one groove machined in the exterior wall of said cone, said at least one groove in abutting contact with said plurality of inwardly directed tabs on said hardware retaining ring.

14. The luminaire reflector with hardware attachment ring of claim 9 wherein said hardware retaining ring extending on said outer periphery of said reflector cone has an annular cup extending downwardly therefrom, said annular cup having a lower end in contacting relationship with said outer periphery of said reflector cone.

15. The luminaire reflector with hardware attachment ring of claim 14 wherein said annular cup has at least one aperture thereon, said at least one aperture engaging a spring clip, said spring clip extending upward around said hardware retaining ring to compressively engage a lens against a top rim surrounding said upper aperture of said reflector cone.

16. The luminaire reflector with hardware attachment ring of claim 9 wherein said reflector cone has a plurality of spaced apart annularly extending grooves formed thereon for engaging said inwardly directed tabs of said hardware retaining ring.

17. The luminaire reflector with hardware attachment ring of claim 15 wherein said reflector cone further has at least one groove on said outer periphery, said plurality of inwardly directed tabs positioned into at least one of said grooves to prevent upward travel of said hardware retaining ring on said reflector cone.

18. The luminaire reflector with hardware attachment ring of claim 17 wherein each of said plurality of said inwardly directed tabs has a U-shaped cutout forming a first and a second tooth, said first and said second tooth in engagement with said at least one groove, each of said tabs directed inwardly and also directed upwardly by at least about 10°.

19. The luminaire reflector with hardware attachment ring of claim 9 wherein said hardware retaining ring has a torsion spring rotatably affixed and extending outwardly therefrom, said hardware retaining ring having an upwardly extending retention mechanism extending upwardly to a top surface of a lens and retaining said lens adjacent said upper aperture.

20. The luminaire reflector with hardware attachment ring of claim 19 wherein said torsion spring is attached to a luminaire housing and wherein said hardware retaining ring has at least one integral retention spring extending upwardly therefrom towards said lens, said integral retention spring retaining said reflector cone in a luminaire housing.

21. A trim cone with hardware attachment ring, comprising:
a trim cone with an upper aperture and a lower aperture;
a retainer ring extending along the exterior periphery of said trim cone in order to retain a lens adjacent said upper aperture of said trim cone;
frictional engagement means extending inward from said retainer ring for retaining said retainer ring in positional vertical alignment on said trim cone;
a lens positioned around said upper aperture of said trim cone and maintained in position by spring features extending from said retainer ring.

22. The trim cone with hardware attachment ring of claim 21 wherein said spring feature has a hook end at a first distal end and a clasps at an opposite distal end, said hook end affixed directly to said retainer ring, said clasps compressively engaging said lens against said upper aperture of said trim cone.

23. The trim cone with hardware attachment ring of claim 21 wherein said spring feature is a downwardly extending tab compressively engaging said lens against a rim forming said upper aperture.

24. The trim cone with hardware attachment ring of claim 21 wherein said frictional engagement means includes a plurality of inwardly directed teeth engaging an exterior wall of said trim cone.

25. The trim cone with hardware attachment ring of claim 24 wherein said teeth engage at least one annular groove on said exterior wall of said trim cone.

26. The trim cone with hardware attachment ring of claim 21 wherein said retainer ring is a annular flat retainer ring having an outer periphery and an inner periphery, said inner periphery having said frictional engagement means, said frictional means being a plurality of upwardly extending engagement fingers, each of said frictional engagement fingers angled upwardly at about 15° relative to said outer periphery.

27. The trim cone hardware with attachment ring of claim 21 wherein said frictional engagement means is a moment arm extending inwardly from said retainer ring.

28. The trim cone with hardware attachment ring of claim 27 wherein said moment arm is about 0.175 inches long.

29. The trim cone with hardware attachment ring of claim 28 wherein said frictional engagement means extends upwardly at about 15° before installation and is deflected upward at about 30° upon installation of said retainer ring on said trim cone.

30. A luminaire reflector with attachment mechanism, comprising:
a luminaire reflector having an upper aperture and a lower aperture;
hardware support means surrounding an exterior wall of said luminaire reflector and having a plurality of friction means for maintaining the vertical position of said hardware support means on said luminaire reflector.

31. A luminaire reflector and hardware attachment ring combination, comprising:
a luminaire reflector having an upper aperture and a lower aperture, said upper aperture defining a first plane, said lower aperture defining a second plane, said first plane at an angle relative to said second plane;
a lens placed on said reflector above said upper aperture;
a retaining ring surrounding an exterior wall of said reflector and having an inwardly directed frictional engagement mechanism for engaging said reflector and maintaining the vertical position of said retaining ring;
a plurality of upwardly extending retention clips affixed at a first end to said retaining ring and downwardly compressing said lens against said reflector adjacent said upper aperture.
